(19) United States
(12) Patent Application Publication
(10) Pub. No.: US 2026/0284497 A1
(43) Pub. Date: Sep. 24, 2026

(54) ROTATIONAL TRAINING DEVICE

(71) Applicant: Robert DiNunzio, Cherry Hill, NJ (US)

(72) Inventor: Robert DiNunzio, Cherry Hill, NJ (US)

(21) Appl. No.: 19/554,976

(22) Filed: Mar. 3, 2026

Related U.S. Application Data
(60) Provisional application No. 63/773,528, filed on Mar. 18, 2025.

(51) Int. Cl. A63B 69/00; F16C 19/30; F16C 33/58

(52) U.S. Cl. CPC A63B 69/0002; F16C 19/30; F16C 33/58; A63B 2069/0008; F16C 2316/30

(57) ABSTRACT

A rotational training device has a circular supporting ball bearing base having an outer ring and an inner ring rotationally engaged within the outer ring. Base supporting members extend from the outer ring and a resilient foot pad overlayed by a protective cover is attached to the ball bearing base.

### RELATED APPLICATION

This application claims the benefit of application S.N. 63/773,528, filed on Mar. 18, 2025.

### FIELD OF THE INVENTION

The present invention relates to training devices designed to enhance rotational power for baseball, softball, golf, boxing, and generally all sports and, in fact for any purpose where rotational efficiency is required for the enhancement of muscle memory in developing proper lower body movement.

### BACKGROUND OF THE INVENTION

In most sports, proper body movement, particularly lower body rotational movement, is critical to establishing optimum athletic performance. Upon continued repetition of the proper rotational movement during practice sessions, this movement will become a part of the athlete's muscle memory. Especially important in developing below hip, lower body strength for such sports as softball, baseball, boxing, and golf, is the proper positioning and rotational, pivotal moment of the athlete's rear foot.

### SUMMARY OF THE INVENTION

It is thus the object of the present invention to provide a rotational foot operated training device for developing muscle memory which is specifically designed to provide the user with optimum lower body power.

This and other objects are accomplished by the present invention, a rotational training device having a circular supporting ball bearing base comprising an outer ring and an inner ring rotationally engaged within the outer ring. Base supporting members extend from the outer ring and a resilient foot pad overlayed by a protective cover is attached to the ball bearing base.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an exploded view of the components of the present invention.

FIG. 2 is a top perspective view of the present invention in its assembled condition.

FIG. 3 is a bottom perspective view of the present invention in its assembled condition.

FIG. 4 is a top perspective view of the present invention with its protective cover removed.

FIG. 5 is a bottom perspective exploded view of the present invention showing its protective cover removed.

FIG. 6 is a top view of the present invention without its protective cover.

FIG. 7 is a bottom view of the present invention.

FIG. 8 illustrates the use of the present invention.

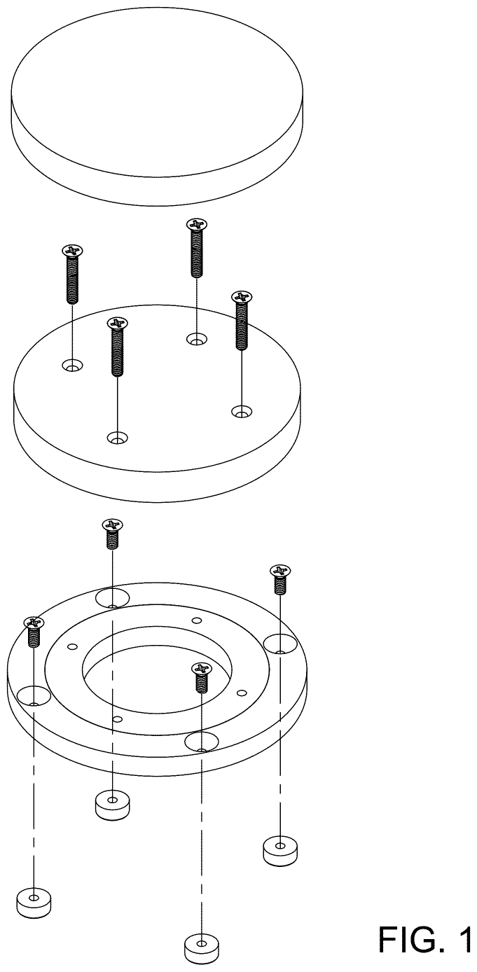

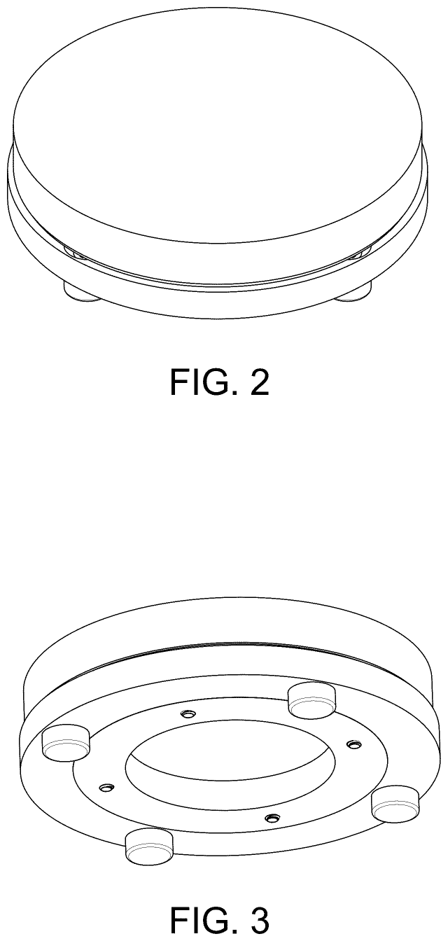

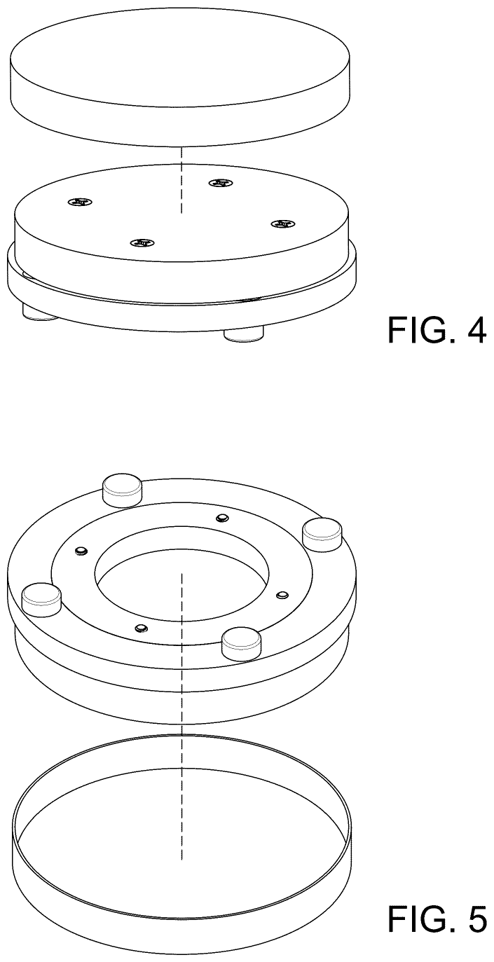

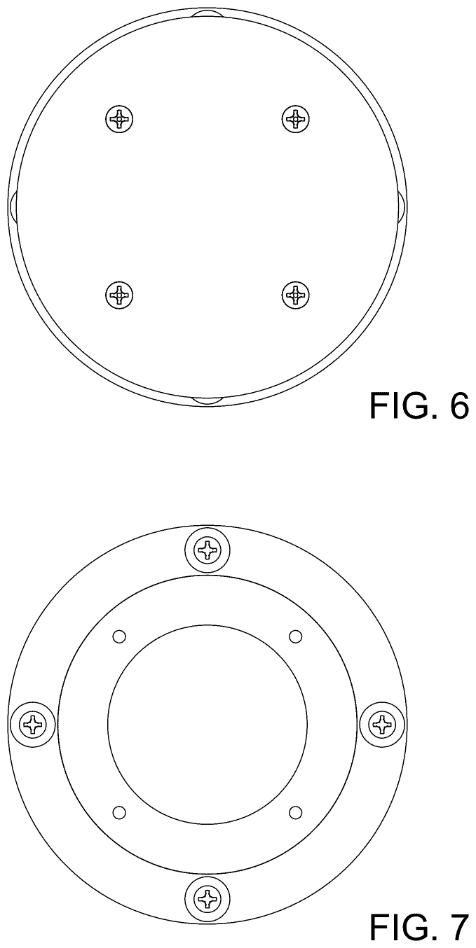

### DETAILED DESCRIPTION OF THE INVENTION

The present invention employs a neuro mechanical performance system or Neuro Torque,™ which is designed to enhance rotational power by training the connection between the brain and torque production. Instead of focusing solely on strength or mechanics, Neuro Torque™ targets the neural signal that drives rotational force in order to improve timing, efficiency, and power transfer across the kinetic chain. While most rotational training tools treat the body like a machine, Neuro Torque™ treats it like a biological system.

The present invention uses the principles of Neuro Torque™ to reinforce muscle memory patterns involved in pivoting and rotation, whether swinging a bat, a racket, a club, or throwing a punch, or for any discipline where rotational efficiency determines performance.

Rotational training device 1 comprises circular supporting ball bearing base 2 having outer ring 4. Inner ring 6 is rotatably engaged within outer ring 4. Base supports 8, 10, 12 and 14 extend from lower surface 5 of outer ring 4. These base supports are secured to outer ring 4 by means of screws 13, 15, 17, and 19 through holes 21, 23, 25, and 27.

Holes 29, 31, 33, and 35 extend through inner ring 6. Resilient foot pad 16 is attached to upper surface 7 of inner ring 6 by screws or like attachments 18, 20, 22, and 24 which extend through holes 37, 39, 41, and 43 in pad 16 and then through holes 29, 31, 33, and 35 in inner ring 6. Protective cover 26 overlays foot pad 16.

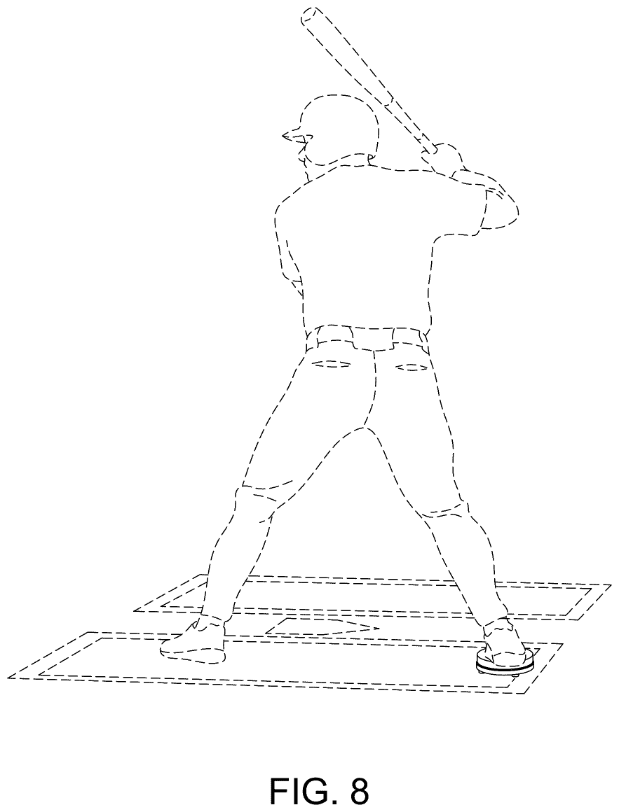

To utilize training device 1, as illustrated in FIG. 8, user 100 positions his or her rear foot 102 on the device and takes the stance required by the particular sport in question. As the user practices the swinging motion, training device 1 will spin/rotate with the rear foot during the swing. This type of training not only teaches the user the proper mechanics of how the pivot foot should be rotating during the swing, thus ensuring that most of the power comes from below the hips and not just from arm strength, it also utilizes Neuro Torque™ to enhance the rotational power by training the link between the brain and torque production; thereby reinforcing the muscle memory involved in pivoting and rotational movements.

For sports, training device 1 is suitable for children and adults who want to learn the correct stance when throwing a punch in boxing, swinging a baseball bat, or driving a ball with a golf club. In these circumstances, the proper stance requires the proper pivoting of the rear foot; and the proper pivoting ensures the most power from the swing.

Training device 1 is not designed to be used while actually playing the sport. Rather, it is designed to be used in the home, office, gym, yard, or other practice facility where the user can stand and move the upper body freely. Repetitive use of training device 1 will enhance technique and create muscle memory for the actual participation in the sport.

It is contemplated that training device 1 would be very useful in other disciplines where proper rotational movement is important, e.g. in the field of physical therapy for the rehabilitation of the hip and lower body.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A rotational training device comprising:
a circular ball bearing base having an outer ring with an upper surface and a lower surface, an inner ring with an upper surface and a lower surface, said inner ring being rotationally engaged within the outer ring, base supporting members extending from the lower surface of the outer ring, and a resilient foot pad attached to the upper surface of the inner ring, wherein the foot of a user is configured to be positioned on the resilient foot pad such that the rotational movement of the user's foot on the training device results in the rotational movement of the lower part of the user's body.

2. The rotational training device as in claim 1 wherein the inner ring has through holes into which screws are inserted to attach the foot pad to the inner ring.

3. The rotational training device as in claim 1 wherein a protective cover overlays the foot pad.
